(19) United States
(12) Patent Application Publication
(10) Pub. No.: US 2018/0357663 A1
(43) Pub. Date: Dec. 13, 2018

(54) FRACTIONAL ADVERTISING PLATFORM

(71) Applicant: Steven Lockstone, Double Bay, NSW (AU)

(72) Inventor: Steven Lockstone, Double Bay, NSW (AU)

(21) Appl. No.: 16/061,025

(22) PCT Filed: Dec. 9, 2016
(86) PCT No.: PCT/AU2016/000395

§ 371 Date: Jun. 11, 2018

(30) Foreign Application Priority Data
Dec. 9, 2015 (AU) 2015905105

(51) Int. Cl. G06Q 30/02

(52) U.S. Cl. CPC G06Q 30/0243; G06Q 30/0273; G06Q 30/0277

(57) ABSTRACT

The present invention provides a fractional advertising platform comprising an online interactive interface which is provided by a service provider and accessible by at least one business and at least one client/respondent via a communication means of an apparatus, and is in communication with the online interactive interface via a global communications network, an advertising campaign having at least one advert divided into a plurality of sellable units and comprising a Call to Action and wherein the at least one client/respondent are directed to one of the businesses based on a random weighted probability algorithm.

### FIELD OF THE INVENTION

The present invention relates to methods and systems for advertising. In particular, but not exclusively, the present invention relates to a fractional advertising platform. However, it will be appreciated that the present invention has broader application and is not limited to that particular use.

### BACKGROUND TO THE INVENTION

Advertising is a necessity for most businesses in order to promote their goods and/or services and generate new customers and business. Common advertising platforms include television, radio, billboards, newspapers, magazines, internet and cinema. The effectiveness of an advertising campaign is primarily dependent on repetition and consistency and message resonance, size and location within these media platforms. However, these traditional advertising platforms are expensive and small and medium-sized enterprises (SMEs) do not have the budget required for an effective campaign, forcing them to shift their budgets online or forfeit advertising altogether. Accordingly, advertisers are forced to only advertise according to their budget.

In this specification, the terms “comprises”, “comprising” or similar terms are intended to mean a non-exclusive inclusion, such that a fractional advertising campaign that comprises a list of elements does not include those elements solely, but may well include other elements not listed.

### OBJECT OF THE INVENTION

It is a preferred object of the present invention to provide a fractional advertising campaign, that addresses or at least ameliorates one or more of the aforementioned problems of the prior art and/or provides a consumer with a useful or commercial choice.

### SUMMARY OF THE INVENTION

Generally, embodiments of the present invention relate to a fractional advertising platform.

According to one aspect, although not necessarily the broadest aspect, the present invention resides in a fractional advertising platform comprising:

an online interactive interface which is provided by a service provider and is accessible by at least one business and at least one client/respondent via a communication means of an apparatus, and is in communication with the online interactive interface via a global communications network;

an advertising campaign having at least one advert divided into a plurality of sellable units and comprising a Call to Action; and

wherein the at least one client/respondent is immediately directed to one of the businesses upon initiating the Call to Action based on a random weighted probability algorithm.

Preferably, the online interactive interface is in the form of a website.

Preferably, the apparatus includes, but is not limited to, mobile phones, personal, laptop or notebook computers, iPads, tablets, personal digital assistants (PDAs), portable multimedia devices.

Preferably, each sellable unit represents a portion of an advert which is available for purchase by a business, at a fraction of a full advertising campaign price.

Preferably, each business can purchase one or multiple units and will be given a weighting based on the amount of units they have purchased.

Preferably, the advert is brand agnostic and is published with only the smart URL or Click to Call prompt as the single Call to Action on the advert.

Preferably, the smart URL is fully integrated with Google Analytics and third party tracking capabilities.

Preferably, each business has a preferred landing URL where people will be directed when the advertised URL is visited.

Preferably, the fractional advertising platform comprises a reporting dashboard which provides feedback to a business regarding their advertising campaign.

Preferably, all businesses participate in a round, a set number of revolutions where the random weighted probability algorithm generates a result based on the weighting of the participating businesses and percentage of sellable units of the advert they have purchased.

Preferably, each time a client/respondent enters initiates the Call to Action via an apparatus, they will receive a random result based on the weighted percentage share of the business' participating in the round.

Preferably, at the end of each round, each business will have the exact proportion of successful results based on the amount of units of the advert they have purchased.

Preferably, upon initiating the Click to Call prompt, the client/respondent will be asked to enter their postcode or any other required details prior to being directed to a business via a virtual number.

According to one aspect, although not necessarily the broadest aspect, the present invention resides in a method of fractional advertising comprising the following steps:

providing an online interactive interface provided via a service provider and accessible by at least one business and at least one client/respondent via a communication means of an apparatus in communication with the online interactive interface via a global communications network;

providing an advertising campaign having at least one advert divided into a plurality of sellable units and comprising a Call to Action;

directing the at least one client/respondent to one of the businesses upon the client initiating the Call to Action based on a random weighted probability algorithm.

Preferably, the method further comprises all businesses participating in a round, a set number of revolutions where a random algorithm generates a result based on the weighting of the participating businesses.

Preferably, the method further comprises a client/respondent receiving a random result based on the weighted percentage share of the business' participating in the round each time they initiate the Call to Action via an apparatus.

Preferably, the method further comprises at the end of each round, each business having the exact proportion of successful results based on the amount of units of the advert they have purchased.

Further features and forms of the present invention will become apparent from the following detailed description.

### BRIEF DESCRIPTION OF THE DRAWINGS

In order that the invention may be readily understood and put into practical effect, reference will now be made to embodiments of the present invention with reference to the accompanying drawings, wherein like reference numbers refer to identical elements. The drawings are provided by way of example only, wherein:

FIG. 1 shows a schematic diagram of the fractional advertising platform according to an embodiment of the invention;

FIG. 2 shows an advert of the fractional advertising platform divided into a plurality of sellable units;

FIG. 3 shows a working example of an advertising campaign of the fractional advertising platform;

FIG. 4 shows a reporting dashboard of the fractional advertising platform; and

FIG. 5 shows a flowchart of a method of fractional advertising according to an embodiment of the present invention.

Skilled addressees will appreciate that elements in the drawings are illustrated for simplicity and clarity and have not necessarily been drawn to scale. For example, the relative dimensions of some of the elements in the drawings may be distorted to help improve understanding of embodiments of the present invention.

### DETAILED DESCRIPTION OF THE INVENTION

Embodiments of the present invention will be described with reference to a fractional advertising platform. For convenience sake, the fraction will be described herein as a fractional advertising platform in the form of a fractional ownership media buying and distribution platform that enables independent like businesses to own a percentage of a big advertising campaign and receive the proportionate benefit. However, it should be appreciated that embodiments of the present invention can be modified to suit different types of advertising campaigns and advertising media platforms. It will be appreciated that variations may need to be made as required.

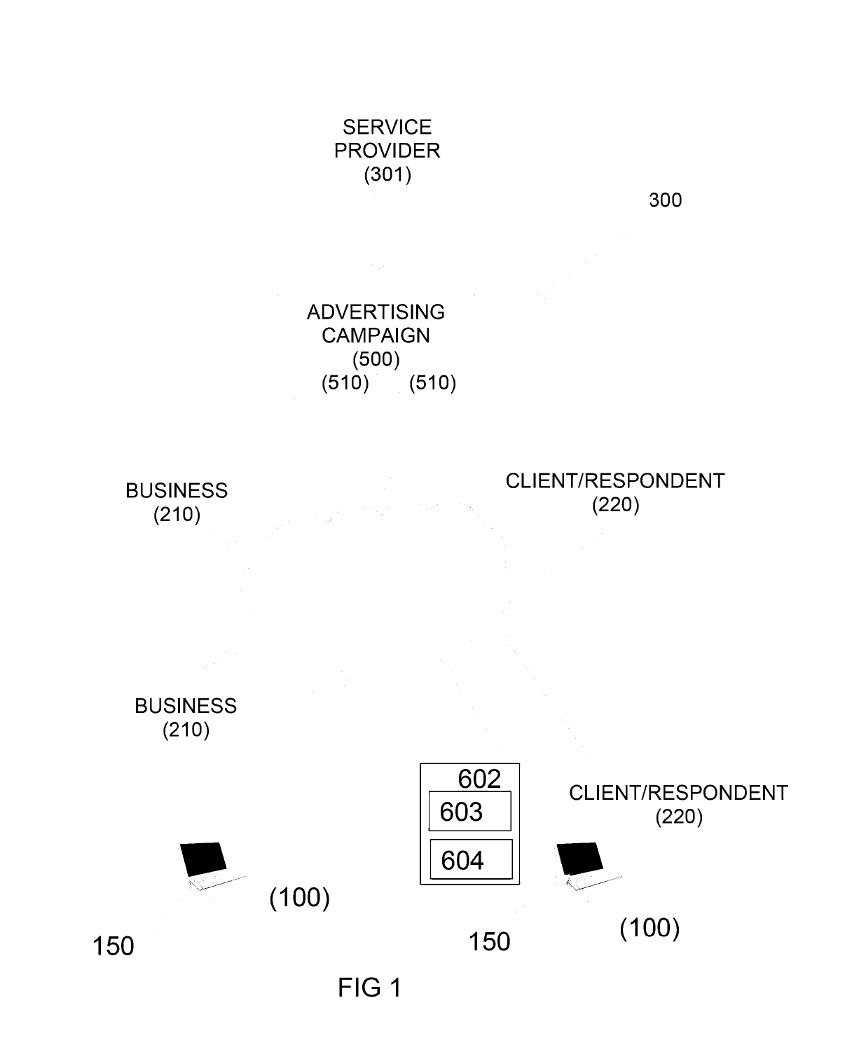

Referring to FIG. 1, the fractional advertising platform 300 is provided in accordance with embodiments of the present invention. The fractional advertising platform 300 has provided a service provider 301 which is adapted to provide a means for, and control and manage, an advertising campaign 500 and the interaction of at least one business 210 that subscribe or sign up to utilise the platform 300 to provide marketing for their business and at least one client/respondent 220 via an online interactive interface 400. The online interactive interface 400, in the form of a website, provides a means for enabling the marketing of businesses and is accessible by the least one business 210 and at least one client/respondent 220 via a communication means 150 of an apparatus 100. Examples of apparatus 100 include, but are not limited to, landlines, mobile phones, personal, laptop or notebook computers, iPads, tablets, personal digital assistants (PDAs), portable multimedia devices, mobile telephones and other suitable communication devices. One or more apparatus 100 can be coupled to be in communication with the online interactive interface 400 via global communications network such as the Internet, via conventional wireless and/or wired connections. It is envisaged that the online interactive interface 400 can be coupled to be in communication with at least one storage device 602, such as a server or the like, comprising a central processing system and database 603 and a random weighted probability algorithm 604.

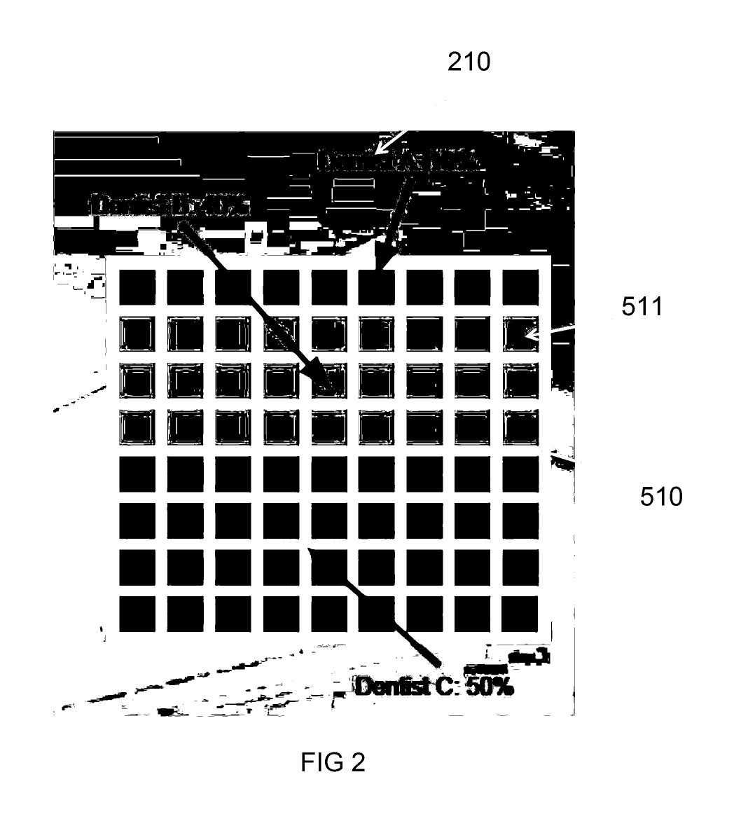

The advertising campaign 500 comprises one or more adverts 510. Referring to FIG. 2, the advert is divided into a plurality of units 511. However, it is envisaged that there will be a maximum amount of units 511 allocated for sale for each advert 510. Each sellable unit 511 represents a portion of an advert which is available for purchase by a business 210, at a fraction of the full campaign price. Each business 210 can purchase one or multiple units to purchase different percentages of the advert. The business 210 will be given a weighting based on the amount of units they have purchased. A weight function will be readily understood by a person skilled in the art as a mathematical device used when performing a sum, integral, or average to give some elements more “weight” or influence on the result that other elements in the same set. In this manner, similar businesses can benefit from a single effective media placement in proportion to their share. As an example illustrated in FIG. 2, Dentist A has a 10% share, Dentist B has a 40% share and Dentist C has a 50% share.

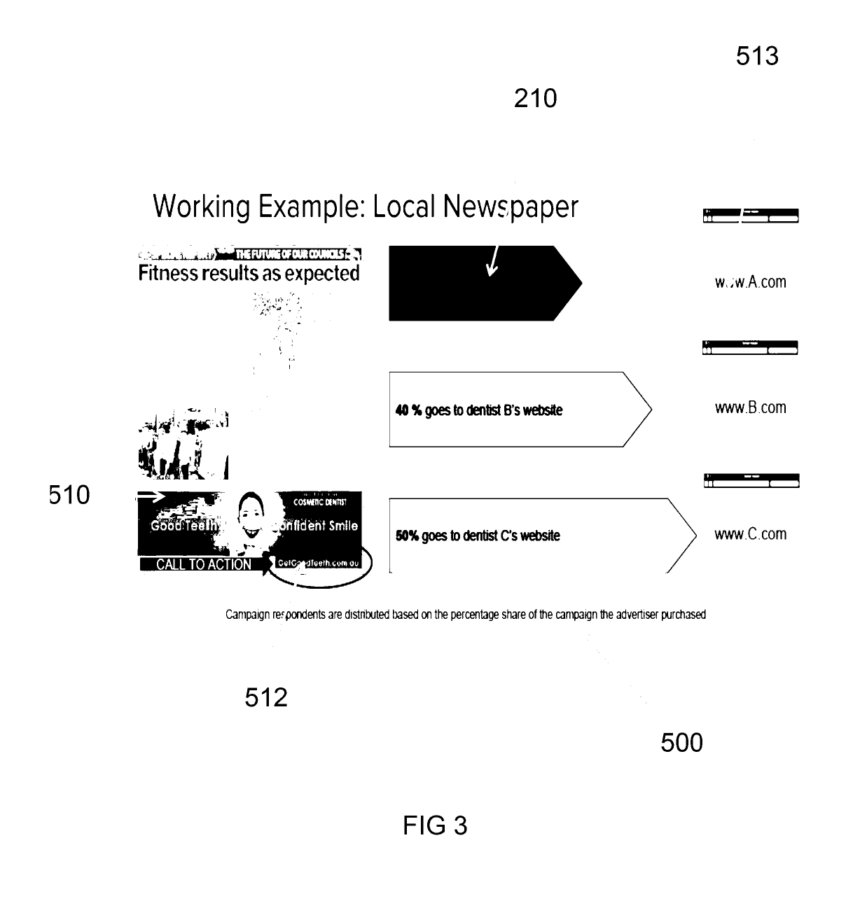

Referring to FIG. 3, the advert 510 is brand agnostic and is published with only a single Call to Action on the advert, which can be a smart URL 512 or Click to Call prompt. However, it is envisaged that the style and type of advertisement 510 may vary across different media platforms. It is envisaged that the business 210 will pay a fixed amount periodically for the advertising campaign 500. However, in an alternative embodiment is it envisaged that the business 210 may Pay Per Action or Bid Per Action, where the Call to Action is a website visit. It is further envisaged, that businesses may pay a premium for single usage advertising. The smart URL 512 is preferably fully integrated with Google Analytics and third party tracking capabilities. Each business has a preferred landing URL 513 where people will be directed when the advertised URL 512 is visited. To the person visiting the advertised URL 512 it appears that the business' website that they land on is the business that paid for the advert. Interested people/respondents 220 who visit the published advert URL 512 are immediately directed to one of the fractional advertiser's own website based on a random weighted probability algorithm 604. The fractional advertising platform 300 uses “EverCookie” technology, commonly known in the marketplace, to provide a consistent experience for the advertiser respondent 220. If the advertiser respondent 220 visits the advertised URL 512 again from the same apparatus 100, they will be directed to the same business 210 that they were directed to in the initial or previous visit.

Where the client/respondent 220 initiates a Click to Call prompt, the client/respondent 220 will be asked to enter their postcode or any other required details prior to being directed to a business 210 via a virtual number. To the person visiting the advert 510 it appears that the business that they are directed to is the business that paid for the advert. Interested people/respondents 220 are immediately directed to one of the fractional advertisers based on the random weighted probability algorithm.

All businesses 210 participate in a round, a set number of revolutions where a random algorithm generates a result based on the weighting of the participating businesses. Each time a client/respondent 220 initiates a Call to Action via an apparatus 100, they will receive a random result based on the weighted percentage share of the business' 210 participating in the round. To the respondent 220, it will appear that a single business has taken the advert 510. At the end of each round, each business 210 will have the exact proportion of successful results based on the amount of units 511 of the advert 510 they have purchased, as illustrated in FIGS. 2 and 3. Each round the algorithm will start calculations from a base level.

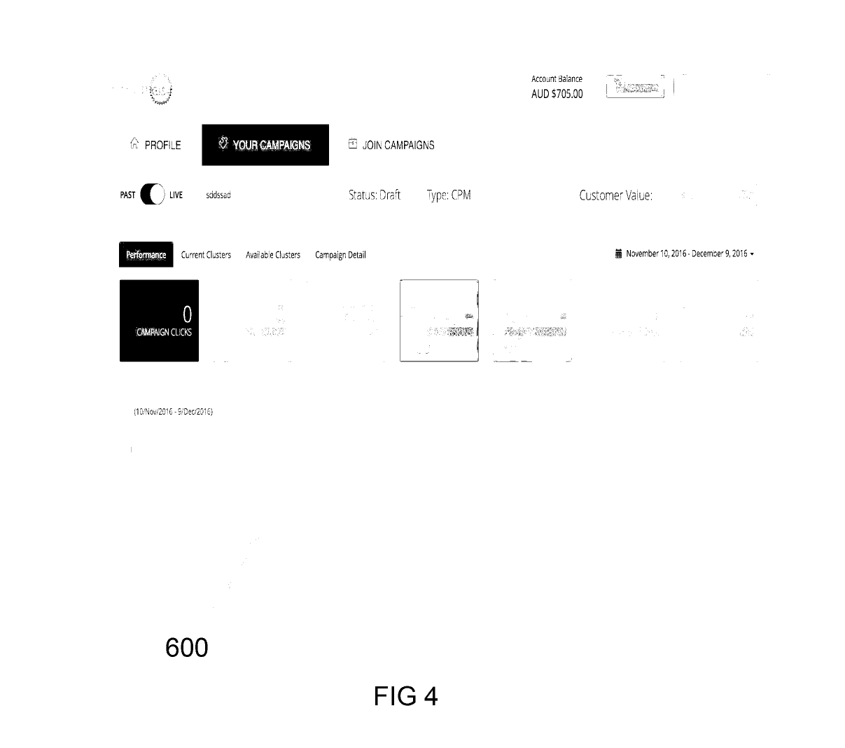

Referring to FIG. 4, the fractional advertising platform 300 comprises a reporting dashboard 600 which provides feedback to a business 210 regarding their advertising campaign 500. In a further embodiment, it is envisaged that the dashboard may be utilised by businesses to adjust their advertising settings. For example, possible modifications include, but are not limited to, payment method (fixed amount, Pay Per Action, Bid Per Action), when the URL/call divert will be active/inactive for their business, limitation of the number of visits received.

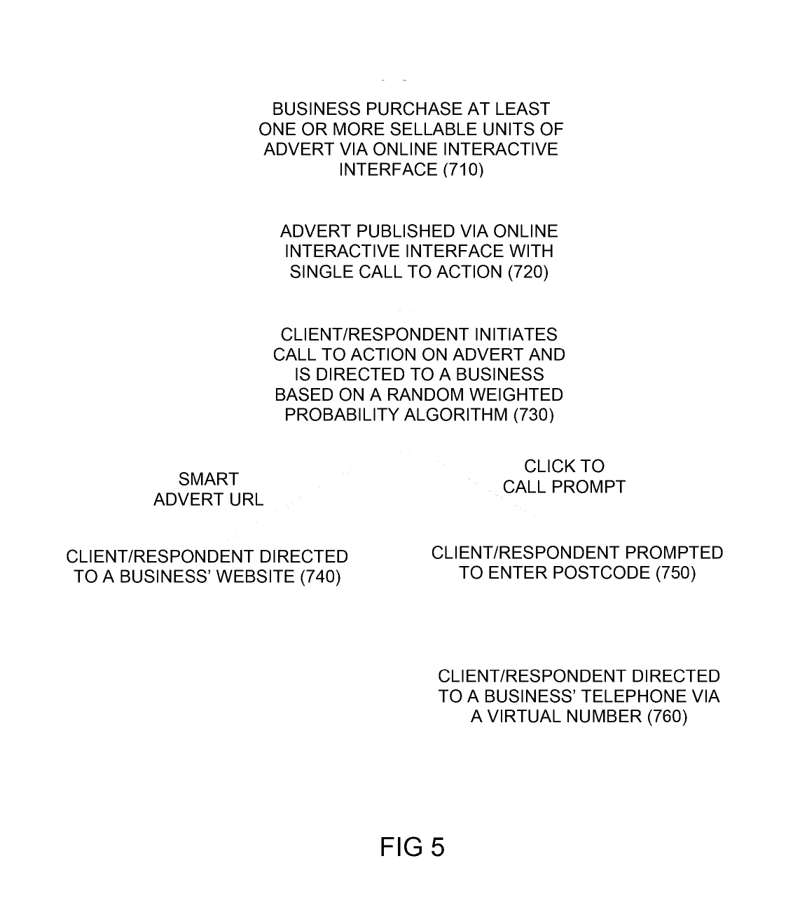

Referring to FIG. 5, the invention further comprises a method of fractional advertising. The method of fractional advertising comprises providing an online interactive interface provided via a service provider and accessible by at least one business and at least one client/respondent via a communication means of an apparatus, providing an advertising campaign having at least one advert divided into a plurality of sellable units purchasable by at least one business at 710 and published comprising a Call to Action at 720, and directing the at least one client/respondent to one of the businesses based on a random weighted probability algorithm at 730 upon the client/respondent initiating the Call to Action. Where the Call to Action is a smart advert URL, the client/respondent will be directed to a business' website at 740. Where the Call to Action is a Click to Call prompt, the client/respondent will be prompted to enter their postcode at 750 prior to being directed to a business' telephone at 760 via a virtual number. The method further comprises all businesses participating in a round, a set number of revolutions where a random algorithm generates a result based on the weighting of the participating businesses. The method further comprises a client/respondent receiving a random result based on the weighted percentage share of the business' participating in the round each time they initiate a Call to Action via an apparatus. The method further comprises at the end of each round, each business having the exact proportion of successful results based on the amount of units of the advert they have purchased.

Hence, the fractional advertising platform provides a solution to the aforementioned problems of the prior art by providing a fractional ownership media buying and distribution platform that enables independent like businesses to own a percentage of a big advertising campaign and receive the proportionate benefit which, enables effective advertising based on budget. The platform provides businesses and advertisers access to economies of scale and reach that they would not be otherwise capable of reaching on their own. Furthermore, the business and advertiser is provided with a dashboard to see their results which can also be integrated with and analysed using readily available software such as Google Analytics to illustrate how effectiveness of the advertising.

The reference to any prior art in this specification is and should not be taken as, an acknowledgment or any form or suggestion that the prior art forms part of the common general knowledge in any country.

Throughout the specification the aim has been to describe the invention without limiting the invention to any one embodiment or specific collection of features. Persons skilled in the relevant art may realize variations from the specific embodiments that will nonetheless fall within the scope of the invention.

I claim:

1. A fractional advertising platform comprising:
an online interactive interface which is provided by a service provider and accessible by at least one business and at least one client/respondent via a communication means of an apparatus, and is in communication with the online interactive interface via a global communications network;
an advertising campaign having at least one advert divided into a plurality of sellable units and comprising a Call to Action; and
wherein the at least one client/respondent is immediately directed to one of the businesses upon initiating the Call to Action based on a random weighted probability algorithm.

2. The fractional advertising platform of claim 1, wherein the online interactive interface is in the form of a website.

3. The fractional advertising platform of claim 1, wherein the apparatus includes, but is not limited to, mobile phones, personal, laptop or notebook computers, iPads, tablets, personal digital assistants (PDAs), portable multimedia devices.

4. The fractional advertising platform of claim 1, wherein each sellable unit represents a portion of an advert which is available for purchase by a business, at a fraction of a full advertising campaign price.

5. The fractional advertising platform of claim 1, wherein each business can purchase one or multiple units and will be given a weighting based on the amount of units they have purchased.

6. The fractional advertising platform of claim 1, wherein the advert is brand agnostic and is published with only the smart URL or Click to Call prompt as the single Call to Action on the advert.

7. The fractional advertising platform of claim 6, wherein the smart URL is fully integrated with Google Analytics and third party tracking capabilities.

8. The fractional advertising platform of claim 6, wherein each business has a preferred landing URL where people will be directed when the advertised URL is visited.

9. The fractional advertising platform of claim 1, wherein the fractional advertising platform comprises a reporting dashboard which provides feedback to a business regarding their advertising campaign.

10. The fractional advertising platform of claim 1, wherein all businesses participate in a round, a set number of revolutions where the random weighted probability algorithm generates a result based on the weighting of the participating businesses and percentage of sellable units of the advert they have purchased.

11. The fractional advertising platform of claim 1, wherein each time a client/respondent enters initiates the Call to Action via an apparatus, they will receive a random result based on the weighted percentage share of the business' participating in the round.

12. The fractional advertising platform of claim 1, wherein at the end of each round, each business will have the exact proportion of successful results based on the amount of units of the advert they have purchased.

13. The fractional advertising platform of claim 6, wherein upon initiating the Click to Call prompt, the client/respondent will be asked to enter their postcode or any other required details prior to being directed to a business via a virtual number.

14. A method of fractional advertising comprising the following steps:
providing an online interactive interface provided via a service provider and accessible by at least one business and at least one client/respondent via a communication means of an apparatus in communication with the online interactive interface via a global communications network;
providing an advertising campaign having at least one advert divided into a plurality of sellable units and comprising a Call to Action;
directing the at least one client/respondent to one of the businesses upon the client initiating the Call to Action based on a random weighted probability algorithm.

15. The method of fractional advertising platform of claim 14, wherein the method further comprises all businesses participating in a round, a set number of revolutions where a random algorithm generates a result based on the weighting of the participating businesses.

16. The method of fractional advertising platform of claim 14, wherein the method further comprises a client/respondent receiving a random result based on the weighted percentage share of the business' participating in the round each time they initiate the Call to Action via an apparatus.

17. The method of fractional advertising platform of claim 14, wherein the method further comprises at the end of each round, each business having the exact proportion of successful results based on the amount of units of the advert they have purchased.
